(19) United States
(12) Patent Application Publication
(10) Pub. No.: US 2015/0199694 A1
(43) Pub. Date: Jul. 16, 2015

(54) DEALERSHIP PROCESS

(71) Applicant: DEMANDX LLC, Midland, TX (US)

(72) Inventors: Jared Davis, Midland, TX (US); Fred Darnell, Charlotte, NC (US)

(21) Appl. No.: 14/598,144

(22) Filed: Jan. 15, 2015

Related U.S. Application Data
(60) Provisional application No. 61/927,652, filed on Jan. 15, 2014.

(51) Int. Cl. G06Q 30/00; G06Q 30/02

(52) U.S. Cl. CPC G06Q 30/018; G06Q 30/0276; G06Q 40/025

(57) ABSTRACT

A computer-implemented method and computing system for receiving, at a computing device, one or more parameters associated with a sales event, wherein the one or more parameters include at least one designated state. Embodiments may further include storing one or more state compliant templates in a database electronically accessible by the computing device and retrieving from the one or more state compliant templates, at least one template corresponding to the designated state. Embodiments may further include automatically auditing, at the computing device, the at least one template corresponding to the designated state for legal compliance and displaying a preview of the at least one template, after auditing has been performed.

### CROSS-REFERENCE TO RELATED APPLICATIONS

This application claims the benefit of U.S. Provisional Application having Ser. No. 61/927,652, filed Jan. 15, 2014, of which the entire contents are incorporated herein by reference.

### TECHNICAL FIELD

This disclosure relates to sales processes and, more particularly, to an automated method for automatically generating legally compliant templates for use in a sales and event management system.

### BACKGROUND

Sales events often utilize various marketing campaigns in order to reach as many potential customers as possible. These marketing campaigns may include various mailers and other advertising materials, which must comply with federal and state regulations. As such, the companies running these campaigns must ensure attorney general and red flag compliance (e.g. by not disclosing sensitive customer data, etc.).

### SUMMARY OF DISCLOSURE

In a first implementation, a computer-implemented method includes receiving, at a computing device, one or more parameters associated with a sales event, wherein the one or more parameters include at least one designated state. The method may further include storing one or more state compliant templates in a database electronically accessible by the computing device and retrieving from the one or more state compliant templates, at least one template corresponding to the designated state. The method may further include automatically auditing, at the computing device, the at least one template corresponding to the designated state for legal compliance and displaying a preview of the at least one template, after auditing has been performed.

One or more of the following features may be included. Automatically auditing may include searching for one or more pre-defined keywords. The method may further include determining if one or more sales prospects associated with the sales event require credit repair and transmitting prospect information to a credit repair system. The method may include receiving one or more appointments based upon the at least one template. The method may include receiving an indication of repaired credit from the credit repair system. The method may also include accessing at least one third party server to retrieve at least one of weather information and directional information. The method may further include transmitting at least one of the weather information and directional information to one or more prospects associated with the sales event. The method may further include generating, at the computing device, an automated credit repair option for the prospect. The method may also include transmitting deal formation information to an existing third party dealership management system.

In another implementation, a computing system includes a processor and memory configured to perform operations including receiving, at a computing device, one or more parameters associated with a sales event, wherein the one or more parameters include at least one designated state. Operations may further include storing one or more state compliant templates in a database electronically accessible by the computing device and retrieving from the one or more state compliant templates, at least one template corresponding to the designated state. Operations may further include automatically auditing, at the computing device, the at least one template corresponding to the designated state for legal compliance and displaying a preview of the at least one template, after auditing has been performed.

One or more of the following features may be included. Automatically auditing may include searching for one or more pre-defined keywords. Operations may further include determining if one or more sales prospects associated with the sales event require credit repair and transmitting prospect information to a credit repair system. Operations may include receiving one or more appointments based upon the at least one template. Operations may include receiving an indication of repaired credit from the credit repair system.

In another implementation, a non-transitory computer-readable storage medium having stored thereon instructions that when executed by a machine result in one or more operations is provided. Operations may include receiving, at a computing device, one or more parameters associated with a sales event, wherein the one or more parameters include at least one designated state. Operations may further include storing one or more state compliant templates in a database electronically accessible by the computing device and retrieving from the one or more state compliant templates, at least one template corresponding to the designated state. Operations may further include automatically auditing, at the computing device, the at least one template corresponding to the designated state for legal compliance and displaying a preview of the at least one template, after auditing has been performed.

One or more of the following features may be included. In some embodiments, automatically auditing may include searching for one or more pre-defined keywords. Operations may include determining if one or more sales prospects associated with the sales event require credit repair and transmitting prospect information to a credit repair system.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes dealership process according to an embodiment of the present disclosure;

FIG. 2 is a flowchart of dealership process of FIG. 1 according to an embodiment of the present disclosure;

FIG. 3 is a diagrammatic view of a dealership process according to an embodiment of the present disclosure;

FIG. 4 is a diagrammatic view of a dealership process according to an embodiment of the present disclosure;

FIG. 5 is a diagrammatic view of a dealership process according to an embodiment of the present disclosure;

FIG. 6 is a diagrammatic view of a dealership process according to an embodiment of the present disclosure;

FIG. 7 is a diagrammatic view of a computing device according to an embodiment of the present disclosure;

FIG. 8 is a diagrammatic view of a dealership process according to an embodiment of the present disclosure; and

FIG. 9 is a diagrammatic view of a dealership process according to an embodiment of the present disclosure.

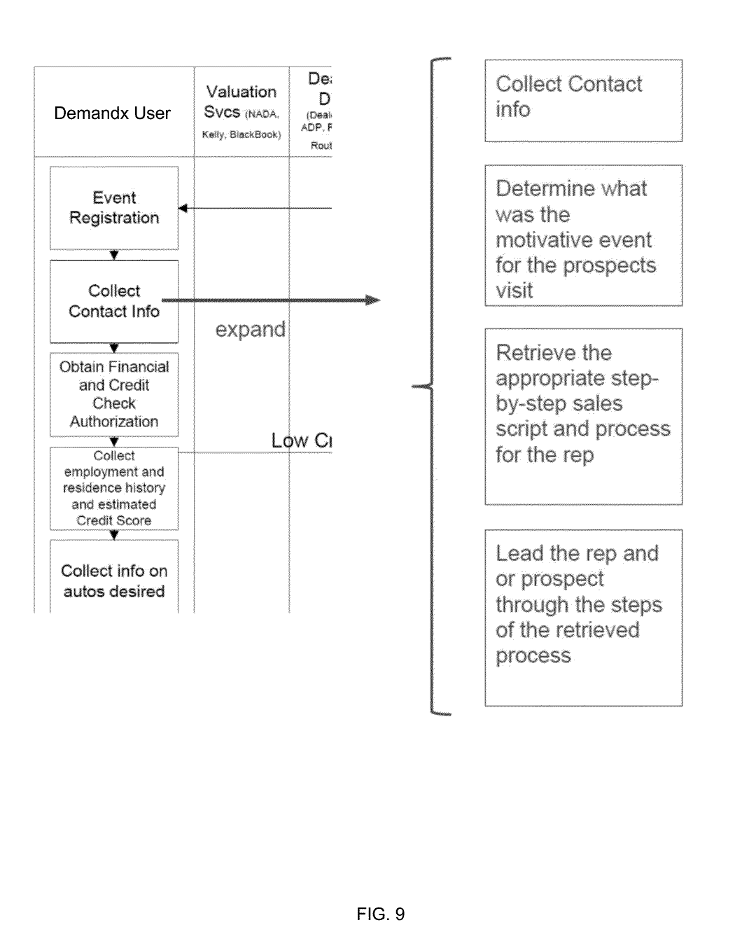

Like reference symbols in the various drawings indicate like elements.

### DETAILED DESCRIPTION OF THE EMBODIMENTS

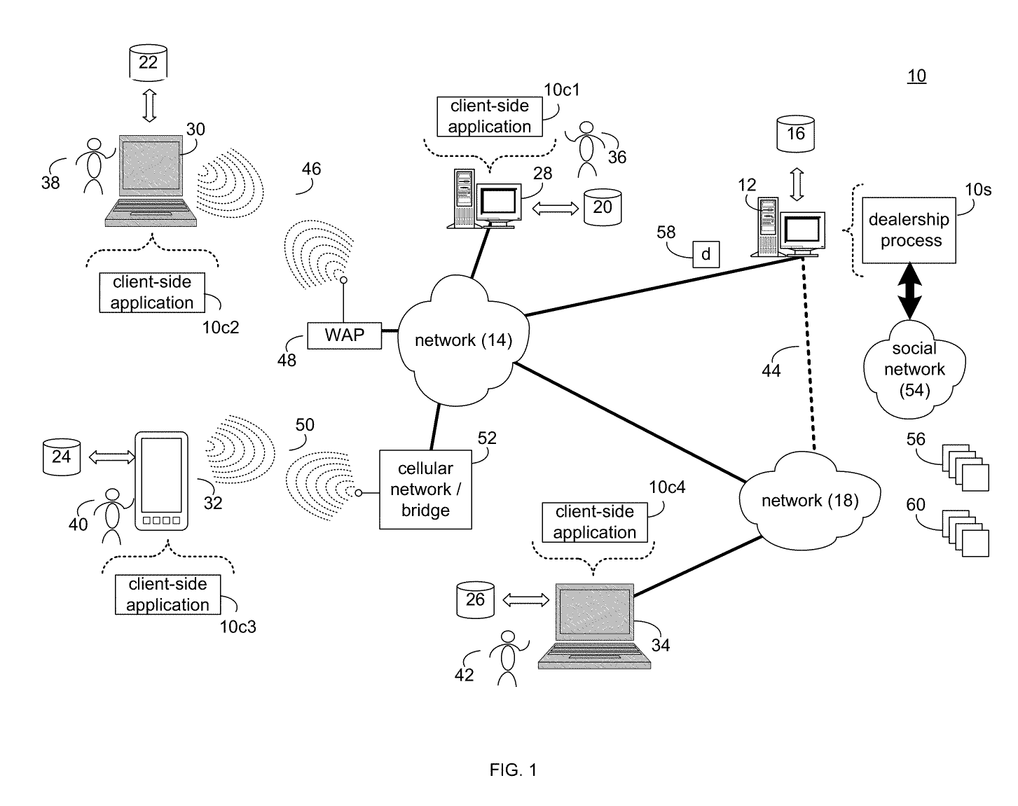

Referring to FIG. 1, there is shown dealership process 10. For the following discussion, it is intended to be understood that dealership process 10 may be implemented in a variety of ways. For example, dealership process 10 may be implemented as a server-side process, a client-side process, or a server-side/client-side process. Any user, if they so choose, may elect to disable any or all of the features associated with dealership process 10.

For example, dealership process 10 may be implemented as a purely server-side process via dealership process 10s. Alternatively, dealership process 10 may be implemented as a purely client-side process via one or more of client-side application 10c1, client-side application 10c2, client-side application 10c3, and client-side application 10c4. Alternatively still, dealership process 10 may be implemented as a server-side/client-side process via dealership process 10s in combination with one or more of client-side application 10c1, client-side application 10c2, client-side application 10c3, and client-side application 10c4.

Accordingly, dealership process 10 as used in this disclosure may include any combination of dealership process 10s, client-side application 10c1, client-side application 10c2, client-side application 10c3, and client-side application 10c4.

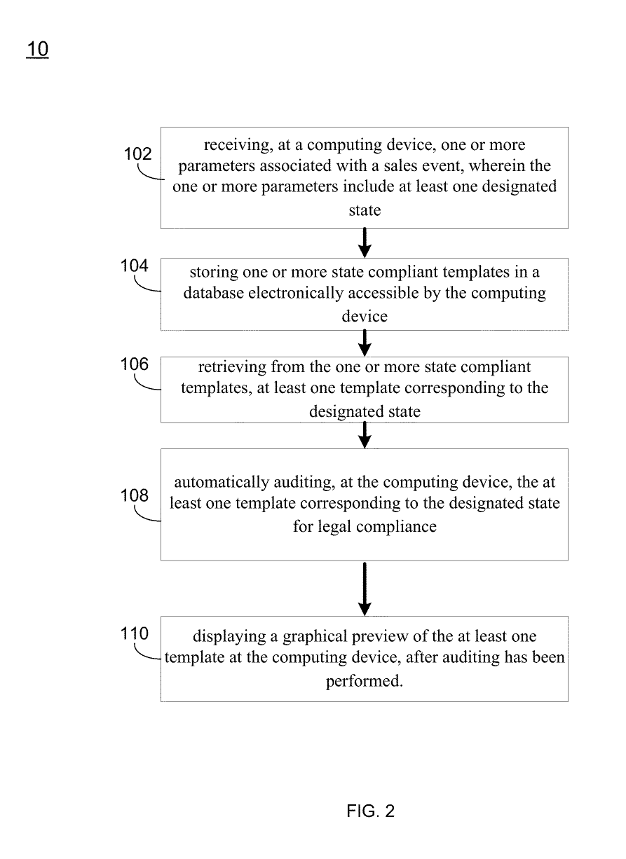

Referring also to FIG. 2 and as will be discussed below in greater detail, dealership process 10 may receive (102) at a computing device, one or more parameters associated with a sales event, wherein the one or more parameters include at least one designated state. Dealership process 10 may further include storing (104) one or more state compliant templates in a database electronically accessible by the computing device and retrieving (106) from the one or more state compliant templates, at least one template corresponding to the designated state. Dealership process 10 may also automatically audit (108) at the computing device, the at least one template corresponding to the designated state for legal compliance and display (110) a graphical preview of the at least one template at the computing device, after auditing has been performed.

In some embodiments, dealership process 10 may include storing one or more versions of the state compliant template that may be compliant with one or more manufacturers or brands. As such, this process may perform similar operations to those discussed above with regard to manufacturing/brand compliance and the output of the audited version may include a template that is both state A/G compliant and manufacturing/brand compliant (e.g., if a dealer sells Fords in Montana the event brochure chosen will be compliant to both the state's guidelines and Ford's guidelines).

The term “sales event”, as used herein, may refer to any and all types of events, promotions, sales, etc.

Dealership process 10s may be a server application and may reside on and may be executed by computing device 12, which may be connected to network 14 (e.g., the Internet or a local area network). Examples of computing device 12 may include, but are not limited to: a personal computer, a server computer, a series of server computers, a mini computer, a mainframe computer, or a dedicated network device.

The instruction sets and subroutines of dealership process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a tape drive; an optical drive; a RAID device; an NAS device, a Storage Area Network, a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of client-side applications 10c1, 10c2, 10c3, 10c4 may include but are not limited to a web browser, a game console user interface, a television user interface, or a specialized application (e.g., an application running on a mobile platform). The instruction sets and subroutines of client-side application 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; tape drives; optical drives; RAID devices; random access memories (RAM); read-only memories (ROM), and all forms of flash memory storage devices.

Examples of client electronic devices 28, 30, 32, 34 may include, but are not limited to, desktop computer 28, laptop computer 30, data-enabled, cellular telephone 32, notebook computer 34, a server computer (not shown), a personal gaming device (not shown), a data-enabled television console (not shown), a personal music player (not shown), and a dedicated network device (not shown). Client electronic devices 28, 30, 32, 34 may each execute an operating system, examples of which may include but are not limited to Microsoft Windows™, Android™, WebOS™, iOS™, Redhat Linux™, or a custom operating system.

Users 36, 38, 40, 42 may access dealership process 10 directly through network 14 or through secondary network 18. Further, dealership process 10 may be accessed through secondary network 18 via link line 44.

The various client electronic devices (e.g., client electronic devices 28, 30, 32, 34) may be directly or indirectly coupled to network 14 (or network 18). For example, desktop computer 28 is shown directly coupled to network 14 via a hardwired network connection. Laptop computer 30 is shown wirelessly coupled to network 14 via wireless communication channel 46 established between laptop computer 30 (respectively) and wireless access point (i.e., WAP) 48, which is shown directly coupled to network 14. WAP 48 may be, for example, an IEEE 802.11a, 802.11b, 802.11g, 802.11n, Wi-Fi, and/or Bluetooth device that is capable of establishing wireless communication channel 46 between laptop computer 30 and WAP 48. Further, data-enabled, cellular telephone 32 is shown wirelessly coupled to network 14 via wireless communication channel 50 established between data-enabled, cellular telephone 32 and cellular network/bridge 52, which is shown directly coupled to network 14. Additionally, notebook computer 34 is shown directly coupled to network 18 via a hardwired network connection.

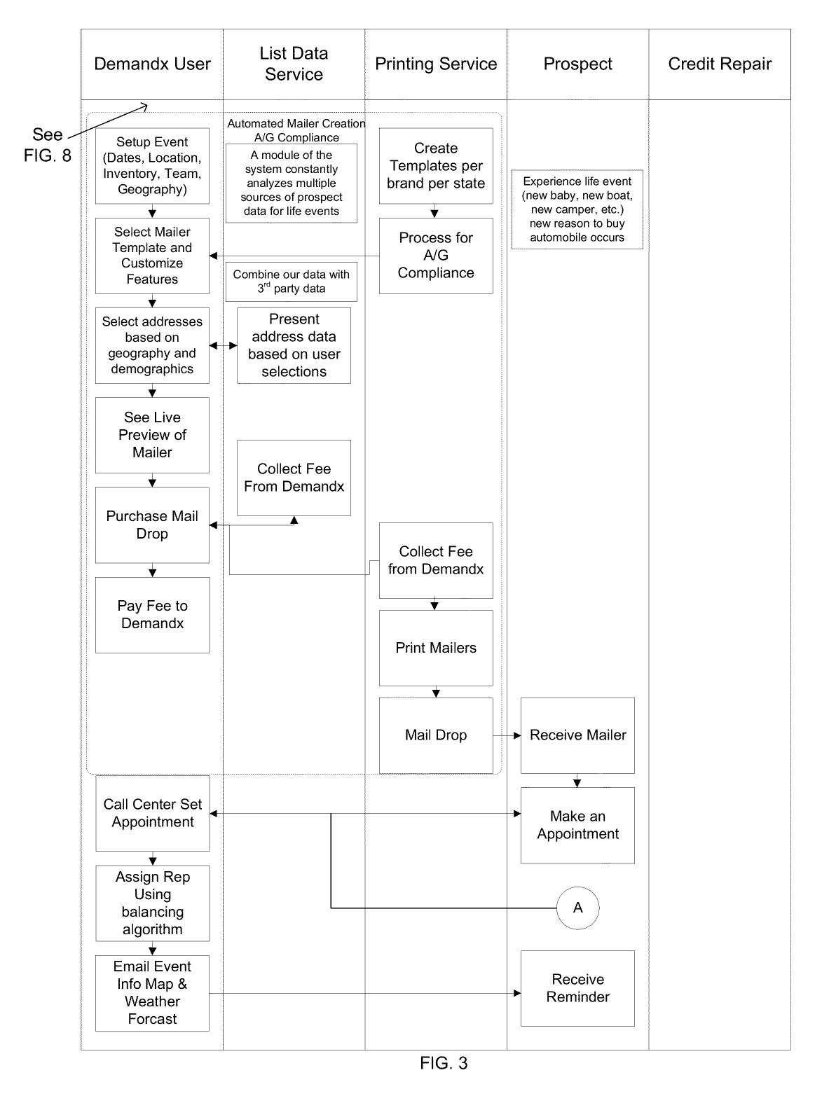

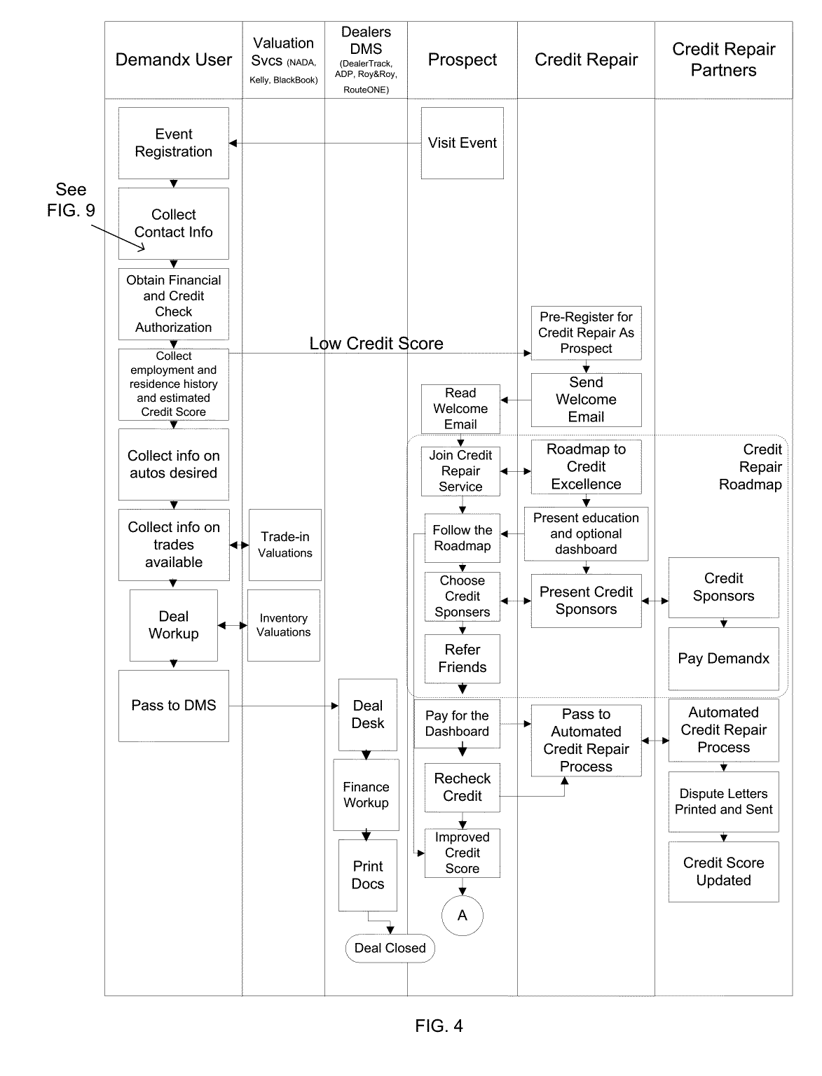

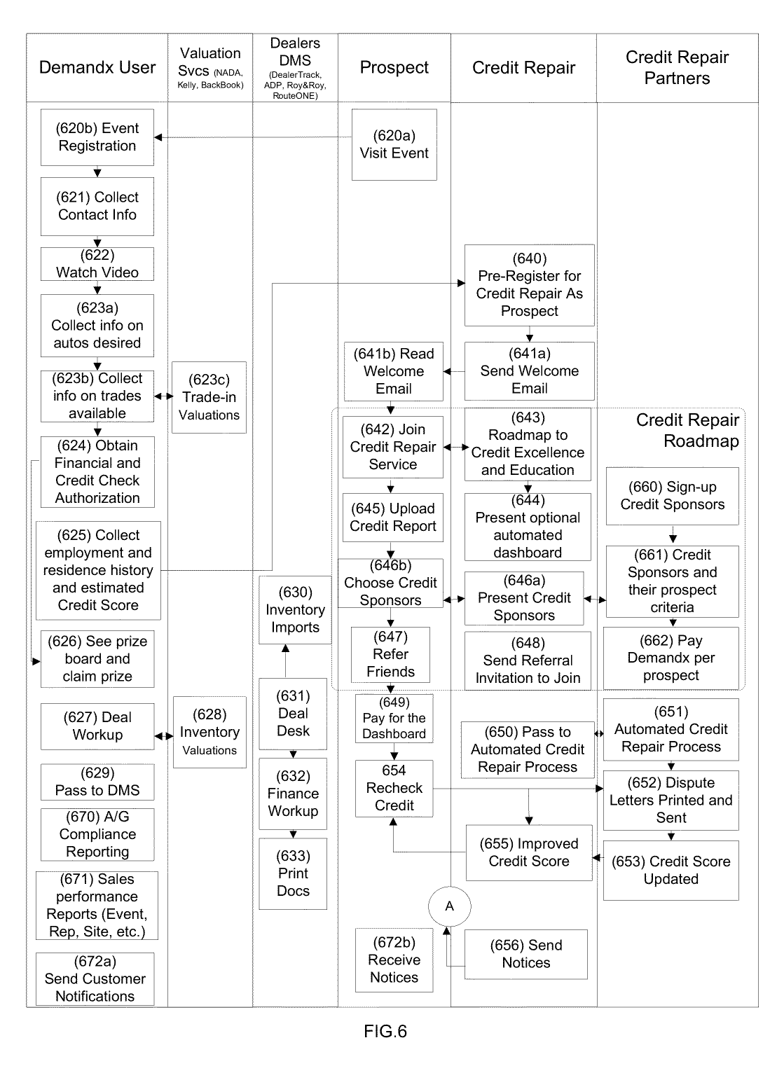

Referring now to FIGS. 3-6 embodiments of dealership process 10 are provided. In some embodiments, dealership process 10 may include a comprehensive software solution, which may be used by numerous industries (e.g., auto dealers) to manage marketing campaigns and sales events. The embodiments provided in FIGS. 3-6 may be used in conjunction with the computing devices, networks, and users depicted in FIG. 1 in any suitable manner.

In some embodiments, dealership process 10 may include a sales management system as well as a consumer credit repair system. In this way, consumers that may be unable to qualify for purchases due to low credit scores may be referred to the credit repair system for credit score improvement then referred back to the sales management system. The systems may be integrated and may rely on several other third-party integrations for additional functionality. Though the system is flexible such that it is used for all types of campaigns, a sales event is described in further detail hereinbelow by way of example.

In some embodiments, dealership process 10 may be configured to define user roles and security levels to limit access to data or functionality. For example, data may be sharable within sales teams, but not shareable across franchises. Roles such as administrator, sales representative, team leader, call center operator, manager, closer, etc. may be used to prevent and/or allow access to data and functions as required.

In some embodiments, dealership process 10 may include a library of state compliant mailers and/or templates that may also comply with terms and conditions set forth by each auto manufacturer. These templates may include, but are not limited to, placeholders for campaign specific information such as dealership, sale dates, featured inventory, pictures of inventory, contact information, etc. It should be noted that while some of the examples discussed herein are discussed in the context of attorney general compliance this is provided merely by way of example as dealership process 10 may be configured to ensure compliance with any suitable regulation, federal and state laws, etc.

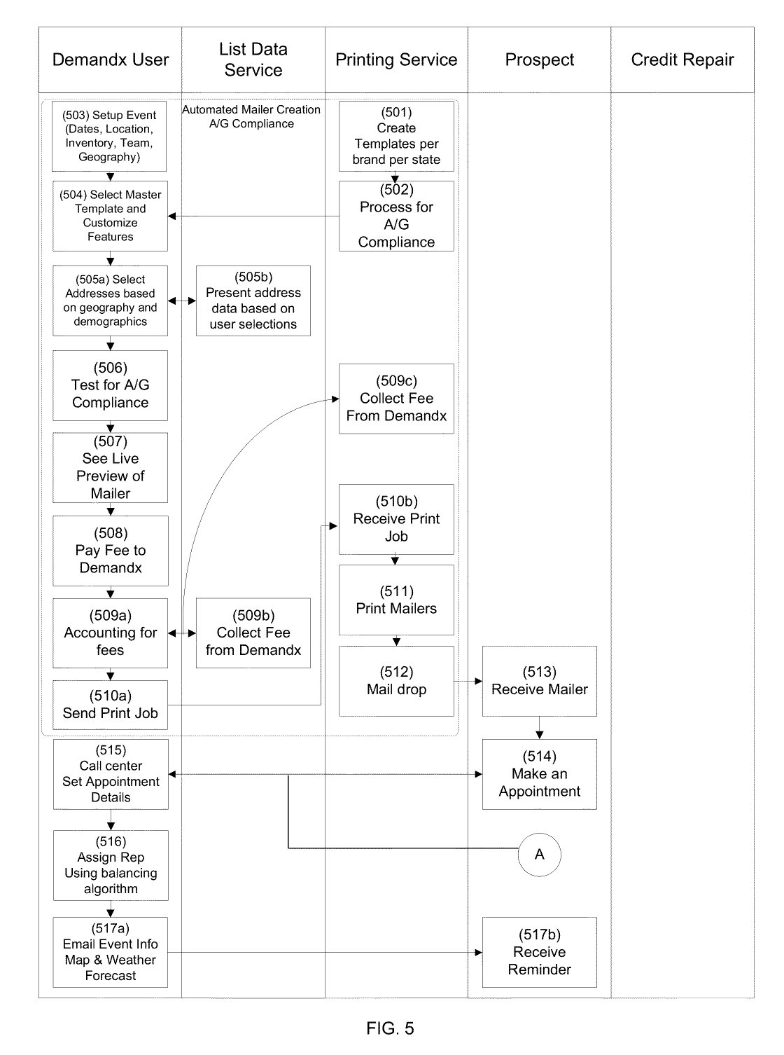

In some embodiments, and referring to FIG. 5, dealership process 10 may be configured to generate one or more mailer templates 501. This may include ensuring that the mailer template is compliant with various regulations for the states for which it is designated (e.g. attorney general regulations, etc.). Dealership process 10 may be configured to handle this using at least one of manual and automated inspection 502.

In some embodiments, and referring to FIG. 3, dealership process 10 may utilize algorithms to search publicly and/or commercially available social media data for the purpose of identifying prospects who have recently experienced a life event that makes them more likely to purchase and defines what vehicle may be most interesting. A manifest may be generated by combining data from marketing activities external to this process as well as data developed by (life event data) or collected within (prior experience data) this process during various operations. The term “manifest”, as used herein, may refer to a collection of names and addresses, which may be selected by geography, life event, and/or other demographic features.

In some embodiments, prior to the start of an event or campaign, the sales manager may access an event set-up module 503 (e.g. using any of the computing devices associated with FIG. 1) and may define the parameters of the event. In this way, inventory stock may be selected and photographed, valuations may be refreshed, dates may be entered, rewards may be described, the sales team may be selected and assigned roles, etc. If available, a sales video in electronic format may be associated with the event.

In some embodiments, dealership process 10 may be configured to generate one or more mailers and/or mailer templates. For example, the event manager may browse a library of available templates 504 which may be automatically limited to those appropriate for the state where the event is held, and the dealership brand allegiance. At this point, various options, some of which may include, but are not limited to, keys and scratch-offs may be selected and added to the mailer. The manager may then describe the geographic reach for the event 505a and the demographics of the ideal prospect. An interactive map may be used to define a geographic area, and lists of demographic choices (e.g. including but not limited to, “home owner or not”, “married or not”, etc.) may be used to define the prospects to which the mailers should be sent. Once the user is satisfied with the criteria the list data service partner creates and transmits 505b the list of names and addresses to dealership process 10, which may be combined with names addresses already stored/selected by process 10.

In some embodiments, dealership process 10 may be configured to perform 506 an automated audit of compliance (e.g. attorney general compliance, etc.). This may include electronically reviewing the content of the mailer and comparing that content to compliant or non-compliant material that is stored in a database such as those shown in FIG. 1. This may include, but is not limited to, automatically searching for key words and/or phrases that have been identified as not in compliance. These may be pre-defined and may be updated as necessary.

In some embodiments, dealership process 10 may be configured to display 507 a print-ready preview at a computing device such as those shown in FIG. 1, which the manager may review and be given the option to approve. This preview may be provided in high-resolution and may be configured to appear exactly as it will look when printed. If acceptable, dealership process 10 may allow the manager to pay (e.g., via credit card or other instant method), the charges 508 accumulated during the mailer creation process. These charges may include, but are not limited to, flat fees, per mailer option fees, fees per address, etc.

In some embodiments, once these fees are accepted, third-party fees may be accounted for within one or more accounting journals 509a associated with dealership process 10. These fees may include, but are not limited to, list data service fees 509b and printing fees 509c. Once fees are received 508 at dealership process 10 the necessary requirements to support printing may be transmitted electronically to the print shop 510a, 510b. Upon receiving the print job request 510b a printing service may produce the mailers 511 in a postal ready format and deliver them to the post office 512 for distribution.

In some embodiments, upon receiving a mailer as an invitation to the event 513, a sales prospect may call and make an appointment 514 as described on the mailer. The call center takes the call, and by requesting and entering the unique number printed on the mailer, dealership process 10 may be configured to associate the call to the record in the database, reducing the amount of data entry. An algorithm may be used to balance appointments across representatives 516 assigned to the event, and an appropriate time-slot may be identified 515. Once the appointment is set, driving directions may be derived from third party systems 517a, weather forecasts may be collected from third-party systems 517a, and an email reminder including map and directions and weather forecast may be sent to the prospect 517b.

In some embodiments, upon arriving at the dealership the prospect may present their mailer to their assigned rep. If they do not have an appointment the next available representative according to the aforementioned balancing algorithm may be selected. The sales representative may enter the unique ID number 520b on the mailer and dealership process 10 may retrieve information previously collected for this prospect. Additional contact information for the prospect is collected and entered 521. Additionally and/or alternatively, if a sales video has been created and associated with the event, the video may be displayed 522 to the prospect.

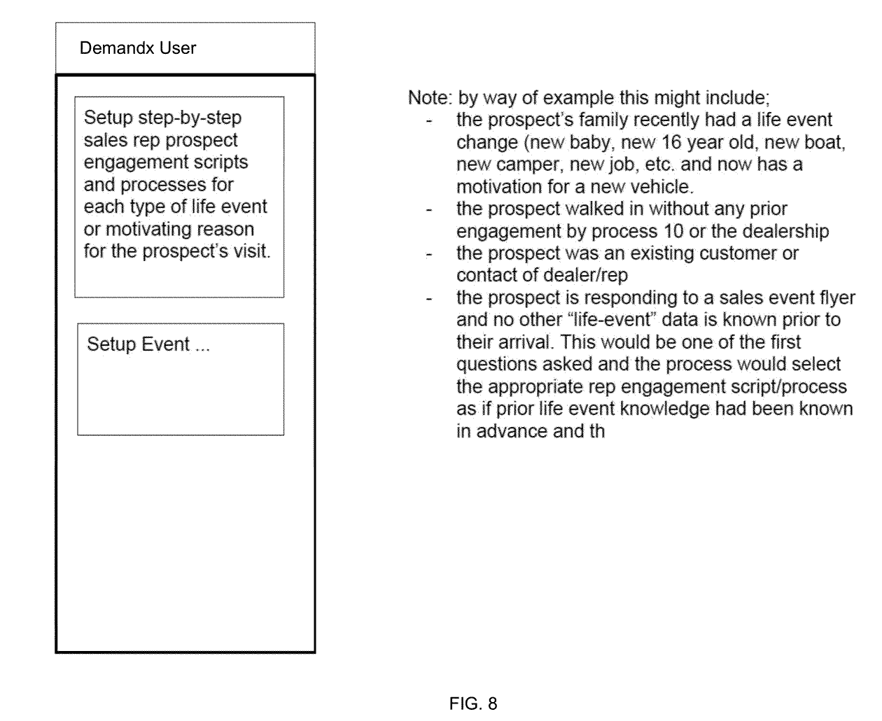

In some embodiments, dealership process 10 may be configured to guide the representative through the sales process based on prior experience data and Process' knowledge of what life event motivated the arrival of the prospect (FIGS. 3 and 8). The data collection process, associated questions asked by the representative, and sales techniques the representative uses to affect the sale are all direct by process 10. Potential inventory may be pre-selected according to its match with the prospects' desires whether stated explicitly or derived from data analysis by process 10.

In some embodiments, dealership process 10 may be configure to recommend matching inventory based on algorithmic selection of inventory. This algorithm selects only the inventory that meets the ability of the prospect's financial needs, insures profitability for the dealer, and ensures appropriate commission for the rep. Inventory selections are presented in two categories. The first category includes all inventory that falls well into acceptable limits and the second is inventory that falls near the limits. These two categories can be used later in the deal closing process to determine if the rep can bypass steps in sales process that require dealer management approval. These selections could be presented in graphical format for inventory selection by the rep or prospect.

Once the video has completed, dealership process 10 may receive information from the sales representative and/or prospect 523a that outlines the characteristics of the vehicle in which they are interested, if this information has not been previously determined by data already collected by process 10. This data may include, but is not limited to, make, model, body style, desired monthly payments, etc. Additionally, similar data may be entered and received 523b with regard to one or more trade-ins. For example, if the prospect has a vehicle to trade and any trades entered are processed automatically to determine their current market value 523c. All data collected regarding vehicles desired, vehicles for trade and their associated valuation data may be stored in the system.

At this point, the prospect or the rep is presented with a list of appropriate vehicles in inventory meeting the needs of the customer, dealer, and rep. The prospect or the rep will select the vehicle of interest.

At this point, the prospect may be asked to give consent 524 for the collection of financial and residential history for the purposes of determining credit worthiness. If consent is given, financial, residential, debt, and credit information may be collected 525. If consent is not given, information collection is stopped, and the process continues with the granting of event rewards if configured, or stopped if no rewards are configured.

If financial information was collected dealership process 10 may initiate a credit check. Accordingly, if a prospect is determined to have insufficient credit capacity, their contact information may be programmatically sent to the credit repair system and they may be automatically preregistered for that process 540. The credit repair process and resulting re-referral back to the sales and event management system, which is described in further detail hereinbelow. If they are determined to have sufficient credit capacity they may not be automatically registered in the credit repair process. In either case, the process continues with the awarding of rewards if configured.

In some embodiments, if rewards have been configured, the unique registration number on the mailer may be matched 526 against the pre-configured list of unique numbers and associated rewards. Prospects with matching numbers are awarded the associated reward. Without regard to any step in the process above, the sales representative can initiate the deal formation process. In this way, any previously collected information may be used, inventory stock items may be selected, financial characteristics of the deal may be entered 527, and valuations, commissions and other fees may be calculated. If the dealership is a customer of another dealership management system (“DMS”) system and dealership process 10 is configured to communicate with other systems (such as those shown in FIG. 1), the deal data may be passed over to the DMS 529 for completion of the contract process. If not, the deal may be processed manually.

In some embodiments, for users of dealership process 10 who are in communication with existing DMS systems, dealership process 10 may proceed according to the specific DMS in place. Common to all of them is the transference of selected stock/inventory and other information from dealership process 10 to the DMS 530, completion of the warranty and other product options 531, completing of the financial terms of the deal including financing arrangements 532, and printing of the final legally binding documents 533.

As discussed above, in some embodiments, dealership process 10 may utilize one or more attorney general compliance reports and sales performance reports. The A/G Compliance Reports 570 may be configured to compile and present information supporting proof of A/G compliance including but not limited to, collecting proof of financial data collection consent, copies of mailers, sales representative identity, licensing images, etc. Sales performance reports 571 may be of any suitable format and serve to track sales performance in a variety of ways, some of which may include, but are not limited to, sales by time period, representative, team, prospect, geography and prospect demographics.

In some embodiments, customers may be given the option to opt-in to various notification methods for receiving sales or service appointment reminders. Accordingly, customers may choose to receive notifications by email, via their social networking account(s), etc. Customers who allow dealership process 10 social link application(s) 572a access to their social networking account may receive notifications 572b and other communications of interest to the user on their social network feed.

In some embodiments, those prospects passed automatically into and pre-registered for the credit repair process 540 may be automatically sent a welcome email 541a, 541b which encourages them to join the automated credit repair process. The email received 541a contains a link to the credit repair process site where the prospect officially joins the credit repair service 542. The prospect may be presented with a graphical step-by-step process referred to as a “road map to credit excellence” 543 describing the benefits of improved credit scores and the steps consumers can take to positively impact their credit score. Additionally and/or alternatively, the prospect may be provided educational booklets in electronic form via dealership process 10 that provide more detailed information regarding credit scores and the credit repair process.

In some embodiments, credit repair prospect's may be provided with the option to purchase an automated credit repair dashboard 544. Additionally, they are encouraged to upload a current copy of their credit report from any of the major credit score report providers. The automated credit repair dashboard service incurs a fee which may be offset by selecting credit sponsors 549.

In some embodiments, dealership process 10 may communicate with one or more credit repair sponsors. These sponsors are previously selected and enter into contractual relationships with the credit repair service 560 associated with dealership process 10. These sponsors define specific criteria and prospect demographics of interest 561, and are listed if applicable when the prospect is presented with credit repair sponsor options 546a for selection 546b. In one particular example, sponsors who are selected may pay per user sponsored 562. Additionally and/or alternatively, prospects may be provided the option to refer others 547 to the service, who are invited to join via an automated welcoming email.

In some embodiments, dealership process 10 may include an automated credit repair dashboard. For example, if a prospect pays the fee 549 for the automated dashboard, experience information collected thus far is transmitted securely 550 to the automated credit repair system operated by a third party 551. Process steps vary for each prospect but commonly include sending automated dispute letters 552 and providing updated credit score information to the referring system 553, 555.

In some embodiments, dealership process 10 may be configured to improve the prospect's credit and to re-enter the dealership for purchasing opportunities. In this way, either by manual effort on the part of the prospect by following the roadmap steps, or by the automated credit repair process, the prospect's credit score may be improved and made apparent to the prospect through rechecking 554, or notification 556. Prospects' data may be updated with improved credit scores and continued marketing via the event management system may be reinitiated.

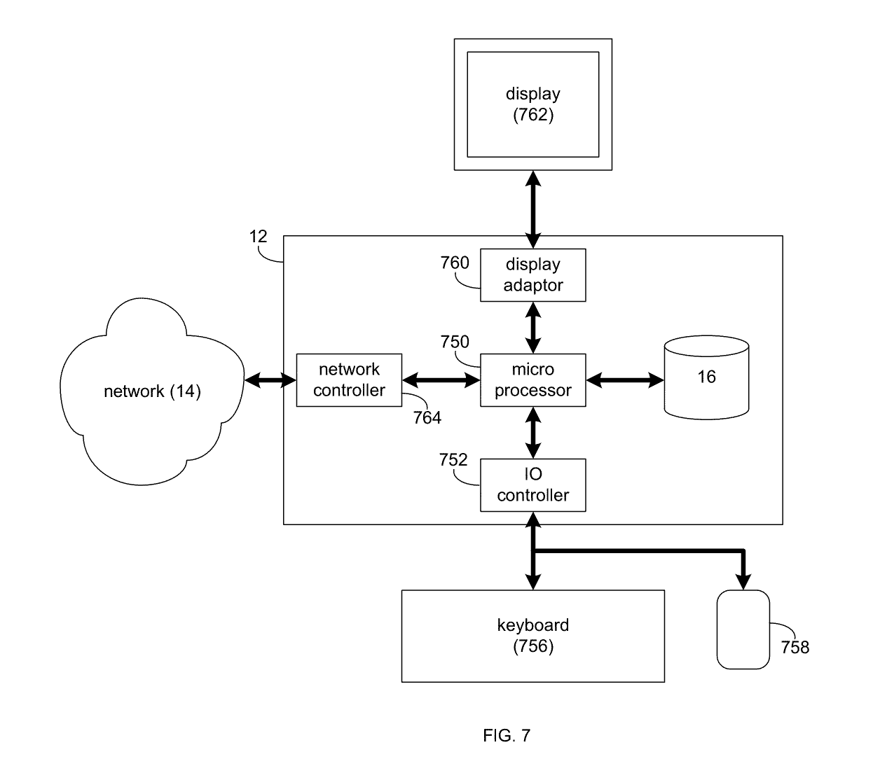

Referring also to FIG. 7, there is shown a diagrammatic view of computing system 12. While computing system 12 is shown in this figure, this is for illustrative purposes only and is not intended to be a limitation of this disclosure, as other configuration are possible. For example, any computing device capable of executing, in whole or in part, dealership process 10 may be substituted for computing device 12 within FIG. 7, examples of which may include but are not limited to client electronic devices 28, 30, 32, 34.

Computing system 12 may include microprocessor 750 configured to e.g., process data and execute instructions/code for dealership process 10. Microprocessor 750 may be coupled to storage device 16. As discussed above, examples of storage device 16 may include but are not limited to: a hard disk drive; a tape drive; an optical drive; a RAID device; an NAS device, a Storage Area Network, a random access memory (RAM); a read-only memory (ROM); and all forms of flash memory storage devices. IO controller 752 may be configured to couple microprocessor 750 with various devices, such as keyboard 756, mouse 758, USB ports (not shown), and printer ports (not shown). Display adaptor 760 may be configured to couple display 762 (e.g., a CRT or LCD monitor) with microprocessor 750, while network adapter 764 (e.g., an Ethernet adapter) may be configured to couple microprocessor 750 to network 14 (e.g., the Internet or a local area network).

As will be appreciated by one skilled in the art, the present disclosure may be embodied as a method (e.g., executing in whole or in part on computing device 12), a system (e.g., computing device 12), or a computer program product (e.g., encoded within storage device 16). Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium (e.g., storage device 16) having computer-usable program code embodied in the medium.

Any suitable computer usable or computer readable medium (e.g., storage device 16) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor (e.g., processor 350) of a general purpose computer/special purpose computer/other programmable data processing apparatus (e.g., computing device 12), such that the instructions, which execute via the processor (e.g., processor 200) of the computer or other programmable data processing apparatus, create means for implementing the functions/acts specified in the flowchart and/or block diagram block or blocks.

These computer program instructions may also be stored in a computer-readable memory (e.g., storage device 16) that may direct a computer (e.g., computing device 12) or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer (e.g., computing device 12) or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Having thus described the disclosure of the present application in detail and by reference to embodiments thereof, it will be apparent that modifications and variations are possible without departing from the scope of the disclosure defined in the appended claims.

What is claimed is:

1. A computer-implemented method comprising:
receiving, at a computing device, one or more parameters associated with a sales event, wherein the one or more parameters include at least one designated state;
storing one or more state compliant templates in a database electronically accessible by the computing device;
retrieving from the one or more state compliant templates, at least one template corresponding to the designated state;
automatically auditing, at the computing device, the at least one template corresponding to the designated state for legal compliance; and
displaying a graphical preview of the at least one template at the computing device, after auditing has been performed.

2. The computer-implemented method of claim 1 wherein automatically auditing includes searching for one or more pre-defined keywords.

3. The computer-implemented method of claim 1 further comprising:
determining if one or more sales prospects associated with the sales event require credit repair.

4. The computer-implemented method of claim 3 further comprising:
transmitting prospect information to a credit repair system.

5. The computer-implemented method of claim 1 further comprising:
receiving one or more appointments based upon the at least one template.

6. The computer-implemented method of claim 4 further comprising:
receiving an indication of repaired credit from the credit repair system.

7. The computer-implemented method of claim 1 further comprising:
accessing at least one third party server to retrieve at least one of weather information and directional information.

8. The computer-implemented method of claim 7 further comprising:
transmitting at least one of the weather information and directional information to one or more prospects associated with the sales event.

9. The computer-implemented method of claim 4 further comprising:
generating, at the computing device, an automated credit repair option for the prospect.

10. The computer-implemented method of claim 1 further comprising:
transmitting deal formation information to an existing third party dealership management system.

11. A computing system including a processor and memory configured to perform operations comprising:
receiving, at a computing device, one or more parameters associated with a sales event, wherein the one or more parameters include at least one designated state;
storing one or more state compliant templates in a database electronically accessible by the computing device;
retrieving from the one or more state compliant templates, at least one template corresponding to the designated state;
automatically auditing, at the computing device, the at least one template corresponding to the designated state for legal compliance; and
displaying a graphical preview of the at least one template at the computing device, after auditing has been performed.

12. The computing system of claim 11 wherein automatically auditing includes searching for one or more pre-defined keywords.

13. The computing system of claim 11 further comprising:
determining if one or more sales prospects associated with the sales event require credit repair.

14. The computing system of claim 13 further comprising:
transmitting prospect information to a credit repair system.

15. The computing system of claim 11 further comprising:
receiving one or more appointments based upon the at least one template.

16. The computing system of claim 14 further comprising:
receiving an indication of repaired credit from the credit repair system.

17. A non-transitory computer-readable storage medium having stored thereon instructions that when executed by a machine result in the following operations:
receiving, at a computing device, one or more parameters associated with a sales event, wherein the one or more parameters include at least one designated state;
storing one or more state compliant templates in a database electronically accessible by the computing device;
retrieving from the one or more state compliant templates, at least one template corresponding to the designated state;
automatically auditing, at the computing device, the at least one template corresponding to the designated state for legal compliance; and
displaying a graphical preview of the at least one template at the computing device, after auditing has been performed.

18. The computer-readable storage medium of claim 17 wherein automatically auditing includes searching for one or more pre-defined keywords.

19. The computer-readable storage medium of claim 17 further comprising:
determining if one or more sales prospects associated with the sales event require credit repair.

20. The computer-readable storage medium of claim 19 further comprising:
transmitting prospect information to a credit repair system.
